(19) United States
(12) Patent Application Publication
(10) Pub. No.: US 2024/0039723 A1
(43) Pub. Date: Feb. 1, 2024

(54) INFORMATION PROCESSING APPARATUS, NON-TRANSITORY COMPUTER READABLE MEDIUM, AND INFORMATION PROCESSING SYSTEM

(71) Applicant: Kabushiki Kaisha Toshiba, Tokyo (JP)

(72) Inventor: Toshio ITO, Yokohama Kanagawa (JP)

(73) Assignee: Kabushiki Kaisha Toshiba, Tokyo (JP)

(21) Appl. No.: 18/180,198

(22) Filed: Mar. 8, 2023

(30) Foreign Application Priority Data
Jul. 26, 2022 (JP) 2022-119047

(51) Int. Cl. H04L 9/32; H04L 9/08

(52) U.S. Cl. CPC H04L 9/3213; H04L 9/0825; H04L 9/3263

(57) ABSTRACT

According to one embodiment, an information processing apparatus, includes: a first token issuer issuing a first token in response to a token issuance demand from a user; a first storage storing information on the user and the first token; a second storage storing ownership registration information of a device owned by the user; a first token acceptor accepting the first token provided from the device; an owner verifier to perform owner verification including verifying whether information on the device providing the first token is stored in the second storage and whether the first token accepted by the first token acceptor matches with the first token in the first storage, and determine the user corresponding to the first token for which the owner verification succeeds as an owner of the device; and a third storage storing verified data including information on the device for which the owner is determined.

### CROSS REFERENCE TO RELATED APPLICATIONS

This application is based upon and claims the benefit of priority from the prior Japanese Patent Application No. 2022-119047, filed on Jul. 25, 2022, the entire contents of which are incorporated herein by reference.

### FIELD

Embodiments described herein relate to an information processing apparatus, non-transitory computer readable medium, and an information processing system.

### BACKGROUND

In a cyber-physical system (CPS), a large number of devices and servers on a cloud form one system by communicating with each other. There is an approach of registering trusted devices and servers that are connection destinations of the respective devices in a server called a registrar in advance in order to protect the system from cyberattack.

Information on a CPS server to which a device is to be connected is stored in a registrar in advance in association with a device certificate. The registrar authenticates the device with use of the device certificate. When the authentication of the accessing device succeeds, the registrar notifies the information on the CPS server associated with the device to the device. As a security risk of the CPS, a case where a third party different from an owner of the device becomes an attacker and obtains the device certificate can be conceived. The attacker can register an unauthorized connection destination server on the registrar with use of the device certificate. In this case, the registrar guides the device to the unauthorized connection destination server. As a result, there is a fear that information leakage from the device, unauthorized control of the device, and the like may occur.

### BRIEF DESCRIPTION OF THE DRAWINGS

FIG. 1 is a system configuration diagram of one example of a CPS according to a first embodiment;

FIG. 2 is a block diagram illustrating one configuration example of a registrar according to the first embodiment;

FIG. 3 is a block diagram illustrating one configuration example of a device according to the first embodiment;

FIG. 4 is one configuration example of a device table according to the first embodiment;

FIG. 5 is one configuration example of a user table according to the first embodiment;

FIG. 6 is one configuration example of an ownership registration table according to the first embodiment;

FIG. 7 is one configuration example of a verified ownership registration table according to the first embodiment;

FIG. 8 is a sequence diagram illustrating the operation of a system in the first embodiment;

FIG. 9 is a flowchart diagram showing the operation of owner verification;

FIG. 10 is a flowchart diagram illustrating the operation of ownership right extinguishment processing;

FIG. 11 is a flowchart diagram illustrating the operation of ownership right transfer processing;

FIG. 12 is a sequence diagram illustrating the operation of a system of a comparative example;

FIG. 13 is a diagram showing a storage example of a connection destination CPS server of the comparative example;

FIG. 14 is a sequence diagram illustrating a security risk of the comparative example;

FIG. 15 is a sequence diagram illustrating the operation when an attack is encountered in the first embodiment;

FIG. 16 is a sequence diagram illustrating the operation of a system in a second embodiment;

FIG. 17 is a system configuration diagram of one example of a CPS according to a third embodiment;

FIG. 18 is a block diagram illustrating one configuration example of a registrar according to the third embodiment;

FIG. 19 is a block diagram illustrating one configuration example of a device according to the third embodiment;

FIG. 20 is one configuration example of an ownership registration table in the third embodiment;

FIG. 21 is one configuration example of a user key table in the third embodiment;

FIG. 22 is one configuration example of an ownership voucher table in the third embodiment;

FIG. 23 is a sequence diagram illustrating the operation of a system in the third embodiment;

FIG. 24 is a system configuration diagram of one example of a CPS according to a fourth embodiment;

FIG. 25 is a block diagram illustrating one configuration example of an owner management server according to the fourth embodiment;

FIG. 26 is a block diagram illustrating one configuration example of an ownership voucher issuance server according to the fourth embodiment;

FIG. 27 is a block diagram illustrating one configuration example of a device according to the fourth embodiment;

FIG. 28 is one configuration example of an owner certification token table in the fourth embodiment;

FIG. 29 is a sequence diagram illustrating the operation of a system in the fourth embodiment; and

FIG. 30 is a flowchart diagram illustrating the operation of owner certification token verification.

### DETAILED DESCRIPTION

According to one embodiment, an information processing apparatus, includes: a first token issuer configured to issue a first token in response to a token issuance demand from a user; a first storage configured to store information on the user and the first token; a second storage configured to store ownership registration information of a device owned by the user; a first token acceptor configured to accept the first token provided from the device; an owner verifier configured to perform owner verification including verifying whether information on the device providing the first token is stored in the second storage and whether the first token accepted by the first token acceptor matches with the first token in the first storage, and determine the user corresponding to the first token for which the owner verification succeeds to be an owner of the device; and a third storage configured to store verified data including information on the device for which the owner is determined.

Embodiments are described below with reference to the drawings.

### First Embodiment

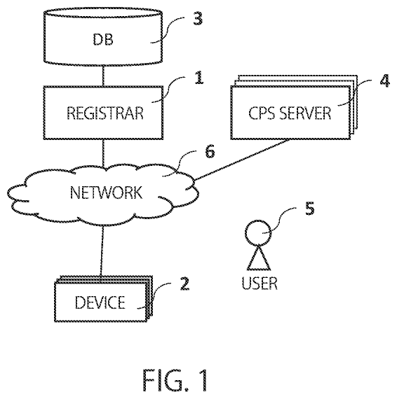

FIG. 1 is a system configuration diagram illustrating one example of a cyber-physical system (CPS) including a registrar (information processing apparatus) 1 according to a first embodiment. The system illustrated in FIG. 1 is configured by a registrar 1, devices 2, a database (DB) 3, and CPS servers 4. An object of the system illustrated in FIG. 1 is to safely perform the initial setting of the devices 2 and the CPS servers 4 and enable the devices 2 and the CPS servers 4 to communicate with each other.

The registrar 1, the database 3, and the CPS server 4 are disposed on a cloud, for example, and are connected to the device 2 owned by a user 5 over a network 6.

The registrar 1 is a server that assists an operation of initially registering the device 2 on the CPS server 4 (normal CPS server) specified by the user and inhibits the device 2 from being guided to an unauthorized CPS server. The registrar 1 includes a structure that verifies whether the user 5 is the proper owner of the device 2 and stores therein and manages the result of the verification by the structure. The registrar 1 guides only the device 2 for which the proper owner (the user 5 herein) is determined by the verification to the CPS server 4 specified by the user 5. By the structure, an attacker is not authorized as the proper owner of the device. Therefore, the device 2 is inhibited from being guided to a CPS server specified by the attacker.

The device 2 is a terminal apparatus that receives any service from the CPS server 4 by communicating with the CPS server 4. The device 2 has a unique private key (device private key) and a digital certificate (device certificate) corresponding thereto.

The database 3 is a storage apparatus for storing therein and managing information readable and writable by the registrar 1.

The CPS server 4 is a server that provides any service to the device 2 by communicating with the device 2.

The user 5 is the owner of device 2, e.g., one person, one robot, or a group of people or robots. The user 5 logins the CPS with use of the device 2. The user 5 creates and owns an own user account on the registrar 1 and the CPS server 4.

The network 6 is a network mainly used by the device 2 to communicate with the registrar 1 and the CPS server 4. The network 6 includes a local area network (LAN) and the Internet, for example.

The registrar 1, the database 3, and the CPS server 4 may be connected to each other in a wired or wireless manner, or the database 3 or the CPS server 4 may be integrated in the registrar 1.

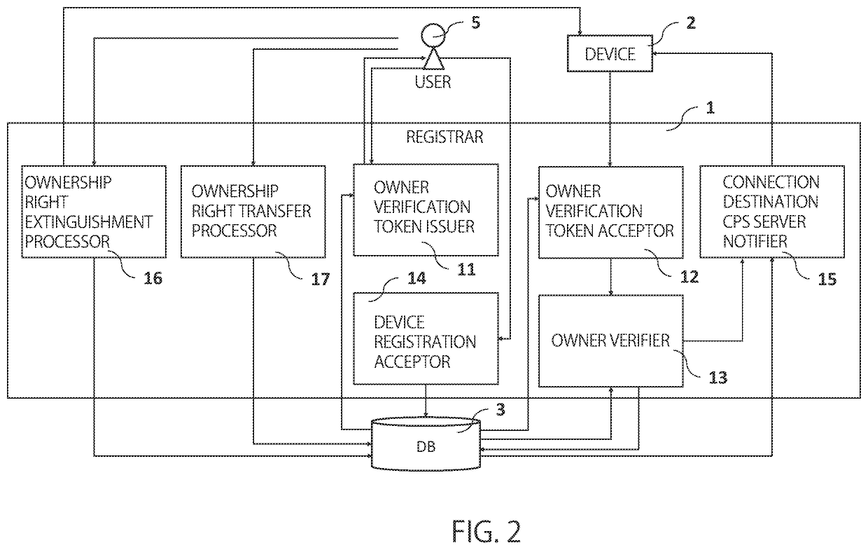

FIG. 2 is a block diagram illustrating one configuration example of the registrar 1 according to the first embodiment. The registrar 1 illustrated in FIG. 2 includes an owner verification token issuer (first token issuer) 11, an owner verification token acceptor (first token acceptor) 12, an owner verifier 13, a device registration acceptor 14, a connection destination CPS server notifier (connection destination notifier) 15, an ownership right extinguishment processor (extinguishment processor) 16, an ownership right transfer processor (authority transfer processor) 17. However, a configuration in which some of these components are not included is also possible. For example, the registrar 1 does not necessarily need to include at least one of the ownership right extinguishment processor (extinguishment processor) 16 and the ownership right transfer processor (authority transfer processor) 17.

The owner verification token issuer 11 issues an owner verification token (first token) in response to a token issuance demand from the user 5 and transmits the owner verification token to the user 5. The owner verification token issuer 11 stores the issued owner verification token in the database 3 in association with information on the user 5. The user 5 can have a user terminal such as a smartphone or a personal computer besides the device 2 and can communicate with the registrar 1 with use of the user terminal. In the description below, the operation performed by the user 5 means the operation performed by the user terminal owned by the user 5. The operation performed with respect to the user 5 is the operation performed with respect to the user terminal owned by the user 5. However, a case where the user 5 may use the device 2 as the user terminal is also possible.

The owner verification token acceptor 12 accepts an owner verification token provided from the device 2 and transmits the owner verification token to the owner verifier 13.

The owner verification token acceptor 12 may perform verification to determine whether the device 2 has a device private key (first encryption key) corresponding to any of device public keys (first decryption keys) stored in the database 3. The owner verification token acceptor 12 may accept an owner verification token based on such verification.

The owner verifier 13 performs verification (hereinafter referred to as owner verification) on whether the information (for example, a device ID) on the device 2 that provided the owner verification token is stored in the database 3, whether the owner verification token accepted by the owner verification token acceptor 12 matches with the owner verification token stored in the database 3, and the like. The specific processing content of the owner verification is described below.

The owner verifier 13 determines the user 5 (hereinafter referred to as a verified user), which corresponds to the owner verification token and for which the owner verification has succeeded, to be the owner of the device 2. The owner verifier 13 stores verified data including the information on the device 2 for which the owner is determined in the database 3. The owner verifier 13 acquires information (for example, a uniform resource locator (URL)) on the connection destination CPS server specified by the verified user from the database 3.

The device registration acceptor 14 accepts a registration request of the device 2 from the user 5. The registration request includes a device certificate of the device 2. The device certificate includes information on a device public key of the device 2. The device registration acceptor 14 stores information including the device certificate in the database 3.

The registration request includes information on the connection destination CPS server specified by the user 5. The device registration acceptor 14 stores the information on the device 2 and the information on the connection destination CPS server in the database 3 in association with each other.

The connection destination CPS server notifier 15 acquires a uniform resource locator (URL), for example, from the owner verifier 13 as information on the connection destination CPS server. The connection destination CPS server notifier 15 notifies the information on the connection destination CPS server to the device 2.

The ownership right extinguishment processor 16 deletes information on the verified user (information indicating that the verified user owns the device 2) from the database 3 by a demand from the verified user.

The ownership right transfer processor 17 rewrites the owner of the device 2 in the database 3 from the verified user to a new user by demands from the verified user and the new user.

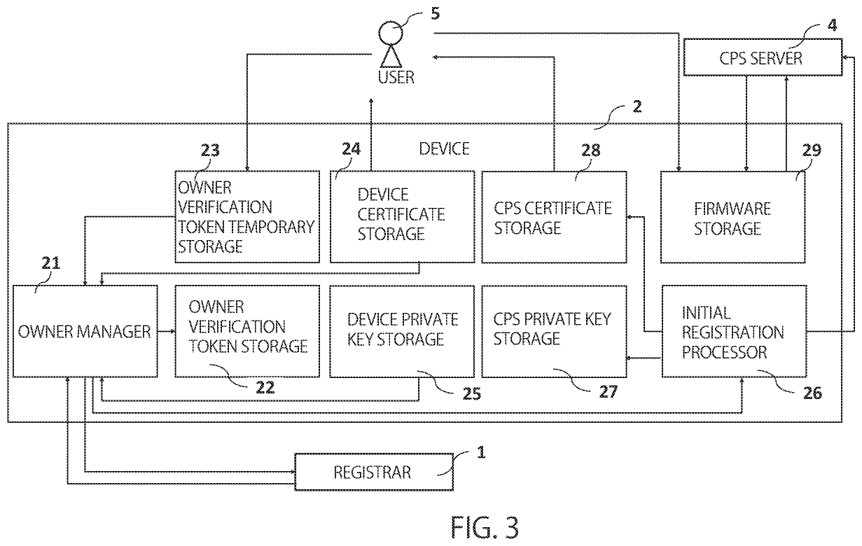

FIG. 3 is a block diagram illustrating one configuration example of the device 2 according to the first embodiment. The device 2 illustrated in FIG. 2 includes an owner manager 21, an owner verification token storage (fifth storage) 22, an owner verification token temporary storage 23, a device certificate storage 24, a device private key storage 25, an initial registration processor 26, a CPS private key storage 27, a CPS certificate storage 28, and a firmware storage 29. The configuration in which some of these components are not included is also possible.

The owner manager 21 manages the owner verification token. The owner manager 21 accepts an owner verification token from the user 5 and stores the owner verification token in the owner verification token storage 22. The owner manager 21 transmits the owner verification token and the like to the registrar 1 and asks for the information (a URL and the like) on the connection destination CPS server. The owner manager 21 may delete the owner verification token stored in the owner verification token storage 22 by receiving an instruction from the registrar 1. The URL and the like of the registrar 1 to be connected are stored in the owner manager 21 in advance.

The owner verification token storage 22 stores therein the owner verification token. The user 5 can read but cannot directly rewrite information in the owner verification token storage 22. The information in the owner verification token storage 22 is rewritten by the owner manager 21.

An expiration date may be set in the owner verification token. The owner manager 21 may store a new owner verification token in the owner verification token storage 22 when the owner verification token is not stored or when the expiration date of the owner verification token has expired.

The owner verification token temporary storage 23 is a storage that temporarily stores therein the owner verification token and can be freely read and written by the user 5. The owner manager 21 reads the owner verification token written in the owner verification token temporary storage 23 and causes the owner verification token storage 22 to store therein the owner verification token.

The device certificate storage 24 stores therein the device certificate. The user 5 can read but cannot rewrite the device certificate. The device certificate is stored therein when the device 2 is manufactured.

The device private key storage 25 stores therein the device private key. The user 5 cannot read nor write the device private key. The device private key is stored therein when the device 2 is manufactured. The owner manager 21 can acquire the device private key from the device private key storage 25.

The initial registration processor 26 receives the information on the CPS server 4 that is the connection destination CPS server from the owner manager 21. The initial registration processor 26 communicates with the CPS server 4 and performs initial registration processing. The initial registration processing includes processing of demanding that the CPS server 4 issue a CPS certificate (certificate for server) created with use of an encryption key (a server private key described below) that the CPS server 4 has.

The device 2 may include the CPS private key storage 27. The CPS private key storage 27 stores therein the CPS private key that the device 2 uses for the authentication with the CPS server 4. The user 5 cannot read nor write the CPS private key. The CPS private key is rewritten by the initial registration processor 26.

The CPS certificate storage 28 stores therein the CPS certificate. The user can read but cannot rewrite the CPS certificate. The CPS certificate is issued by the CPS server 4 and is stored in the CPS certificate storage 28 of the device 2 by the initial registration processor 26.

The firmware storage 29 is a storage that stores therein firmware that controls the operation of the device 2 and can be freely read and written by the user 5. The firmware storage 29 receives a notification of the initial registration completion from the initial registration processor 26 and executes the firmware. The firmware fulfills a function by communicating with the CPS server 4.

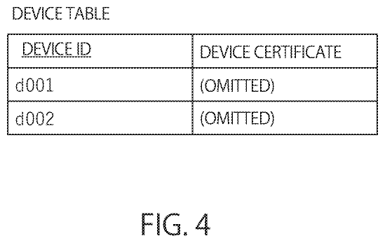

FIG. 4 to FIG. 7 are diagrams showing one example of data stored by the database 3 according to the first embodiment. The database 3 has a device table (fourth storage), a user table (first storage), an ownership registration table (second storage), and a verified ownership registration table (third storage).

FIG. 4 is one configuration example of the device table. The device table is a table that stores therein the device certificate and has the device ID as a primary key.

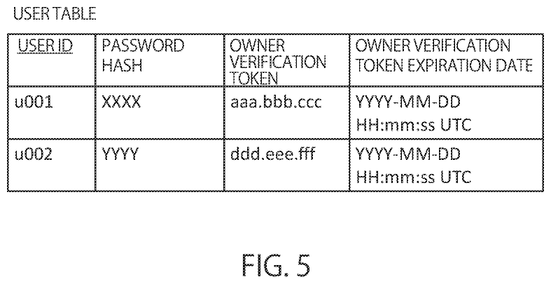

FIG. 5 is one configuration example of the user table. The user table is a table that stores therein the information on the user and the owner verification token in association with each other and has a user ID as the primary key. The user table has a password hash, an owner verification token, and an owner verification token expiration date as other items besides the primary key.

The password hash is a hash value of a login password of the user and is used in the user authentication.

The owner verification token is a character string used for the verification of the owner of the device and a different owner verification token is issued for each user. The owner verification token is issued by the owner verification token issuer 11 of the registrar 1 when an account of the user is newly created, for example. Alternatively, the owner verification token may be issued at other timings, for example, in response to an instruction from the user.

The owner verification token expiration date is an expiration date set for the owner verification token. For example, the expiration date is one week from an issuance time point.

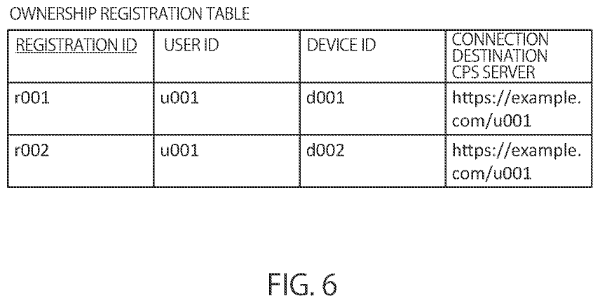

FIG. 6 is one configuration example of the ownership registration table. The ownership registration table is a table that stores therein information (ownership registration information) on a device registered by the user and the URL of a connection destination CPS server on which the device is to perform initial registration. The ownership registration table has a registration ID as the primary key and has the user ID and the device ID as other items. The ownership registration table is linked to the user table and the device table by the user ID and the device ID respectively.

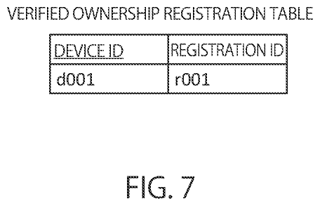

FIG. 7 is one configuration example of the verified ownership registration table. The verified ownership registration table has the device ID of a device for which the owner verification has completed as the primary key and stores therein the registration ID in the ownership registration table corresponding to such device ID. In other words, in the verified ownership registration table, the device, the verified user that is the owner of the device, and the connection destination CPS server specified by the user are associated with each other.

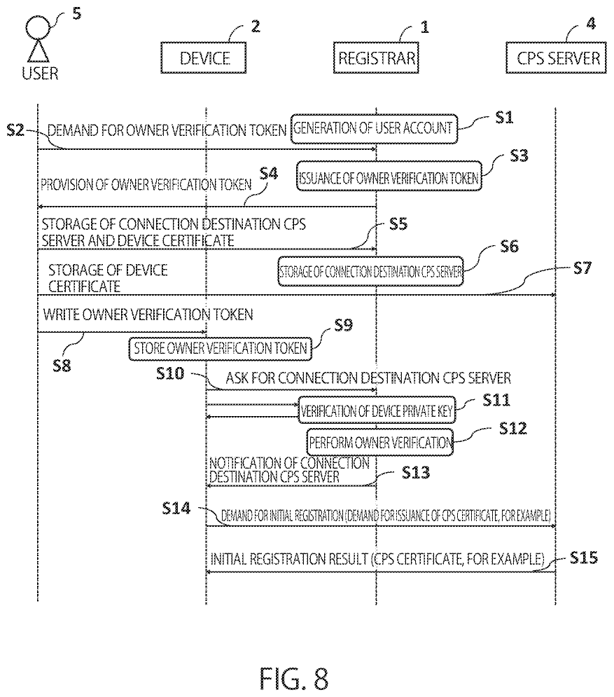

FIG. 8 is a sequence diagram illustrating the operation of the system in the first embodiment. First, in the registrar 1, the user account of the user 5 is created (Step S1). The operation for creating a user account may be performed by the user 5 or may be performed by a person having a predetermined authority (for example, a system manager). In the creation of a user account, a user ID and a login password are transmitted from the user 5. The registrar 1 calculates a password hash from the login password. The registrar 1 stores therein a new entry including the user ID and the password hash in the user table.

The user 5 logs into the registrar 1 and transmits an issuance demand for an owner verification token (Step S2). The owner verification token issuer 11 in FIG. 2 receives the issuance demand and newly issues an owner verification token (Step S3). An expiration date is set in the owner verification token. The owner verification token and the expiration date are stored in the entry of the user 5 in the user table. The owner verification token issuer 11 provides the issued owner verification token to the user 5 (Step S4).

The owner verification token issuer 11 can omit the issuance of a new owner verification token in Step S3 when an owner verification token for which the expiration date has not expired is already stored in the entry of the user 5 in the user table. In this case, the owner verification token stored in the user table may be provided to the user 5 in Step S4.

In Step S1, the owner verification token may be issued at the same time as the creation of a user account, and the owner verification token may be stored in the entry of the user table.

Next, the user 5 acquires the device certificate from the device certificate storage 24 of the device 2. The user 5 specifies the CPS server 4 as the connection destination CPS server. The user 5 transmits a registration request including the device certificate and the URL of the connection destination CPS server to the registrar 1 (Step S5).

The device registration acceptor 14 receives the registration request and stores a new entry including the device ID and the device certificate in the device table. The device registration acceptor 14 stores a new entry including such device ID stored in the device table, the user ID of the user 5, and the URL of the connection destination CPS server in the ownership registration table (Step S6).

The storage of the device certificate into the device table may be performed in advance. In this case, the device registration acceptor 14 reads an entry in the device table having the device certificate extracted from the registration request and acquires the device ID. The device registration acceptor 14 stores a new entry including the acquired device ID, the user ID of the user 5, and the URL of the connection destination CPS server in the ownership registration table.

Next, the user 5 causes the CPS server 4 to store therein the device certificate used in Step S5 (Step S7). As a result, the CPS server 4 can authenticate the device 2 by the stored device certificate.

Next, the user 5 writes the owner verification token acquired in Step S4 in the owner verification token temporary storage 23 in the device 2 (Step S8). At this time, the expiration date of the owner verification token stored in the user table may be written in the device 2 as well. The user 5 activates the owner manager 21 in the device 2 and asks for the reception of the written owner verification token.

The owner manager 21 confirms the content of the owner verification token storage 22. When an owner verification token is not stored in the owner verification token storage 22, the owner manager 21 copies the owner verification token written in the owner verification token temporary storage 23 to the owner verification token storage 22 (Step S9). As with Step S8, the expiration date may be stored in the owner verification token storage 22 as well.

In Step S8, when an owner verification token is already stored in the owner verification token storage 22, the owner manager 21 confirms the expiration date of the owner verification token. The expiration date may be acquired by referring to the content stored in the owner verification token storage 22 or by asking the registrar 1 for the entry in the user table in the database 3. When the expiration date is expired, the owner manager 21 copies (overwrites) the owner verification token in the owner verification token temporary storage 23 to the owner verification token storage 22. When the expiration date is not expired, the owner manager 21 does not copy (overwrite) the owner verification token in the owner verification token temporary storage 23. In this case, the owner manager 21 may notify an error to the user 5.

The owner manager 21 of the device 2 connects to the registrar 1 and asks for the connection destination CPS server (Step S10). Specifically, the owner manager 21 transmits the owner verification token stored in the owner verification token storage 22 and the device certificate stored in the device certificate storage 24 to the registrar 1.

Steps S1 to S9 are initial joining process for the registrar 1 and can be omitted when the device 2 asks for the connection destination CPS server for the second time and thereafter. When the owner of the device 2 is changed, ownership right transfer processing described below can be performed instead of the processing in Steps S2 to S9.

The owner verification token acceptor 12 of the registrar 1 receives the owner verification token and the device certificate from the device 2. At this time, the verification of the device private key may be performed (Step S11). In the verification of the device private key, the owner verification token acceptor 12 verifies whether the device 2 has a device private key corresponding to any of the device public keys stored in the device table. For example, the owner verification token acceptor 12 receives predetermined data encrypted by the device private key from the device 2 and verifies whether the predetermined data can be decrypted by a device public key.

Next, the owner verifier 13 in the registrar 1 performs the owner verification of the device 2 (Step S12). Details of processing of the owner verification are described below. When the owner verification succeeds, the owner verifier 13 reads an entry about the user (verified user) for which the owner verification has succeeded from the ownership registration table. The URL of the CPS server 4 as the connection destination CPS server can be extracted from the entry in the ownership registration table. The owner verifier 13 transmits connection information including the URL of the CPS server 4 extracted from the entry in the ownership registration table to the device 2 (Step S13).

The owner manager 21 in the device 2 gives the URL of the connection destination CPS server to the initial registration processor 26 and asks for the initial registration processing for the connection destination CPS server. The initial registration processor 26 generates a CPS private key and stores the generated CPS private key in the CPS private key storage 27. The initial registration processor 26 generates a certificate signing request (CSR). The CSR includes information such as, for example, a CPS public key and predetermined data. The CSR includes a digital signature applied to such information with use of the CPS private key. The initial registration processor 26 demands the initial registration processing by transmitting the CSR to the connection destination CPS server (Step S14).

The CPS server 4 authenticates the CSR by the device certificate stored in Step S7. The CPS server 4 issues a CPS certificate with use of a server private key that the CPS server 4 has, and then provides the issued CPS certificate to the device 2 (Step S15). When the initial registration processor 26 in the device 2 receives the CPS certificate, the initial registration processor 26 stores the CPS certificate in the CPS certificate storage 28.

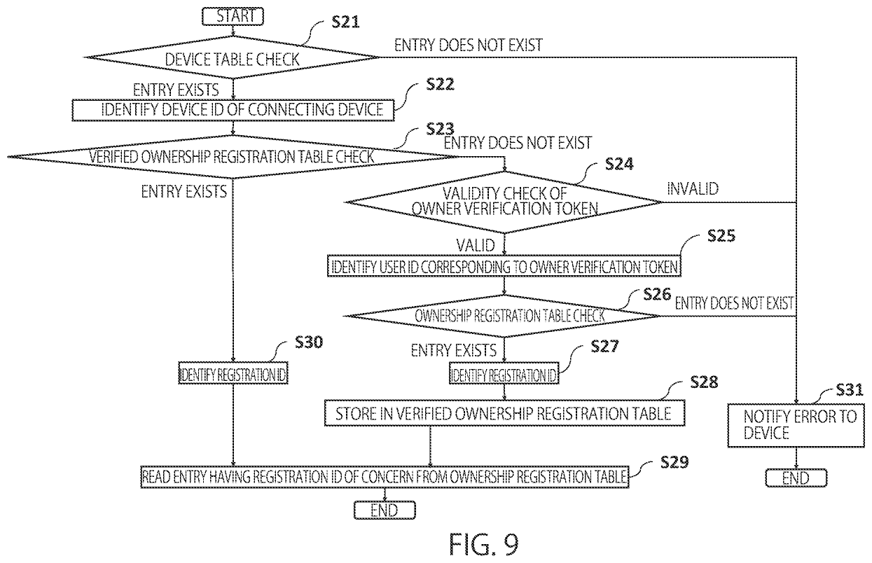

FIG. 9 is a flowchart diagram showing the operation of the owner verification. The owner verification is performed by the owner verifier 13 in the registrar 1 as described above.

First, device table check is performed (Step S21). In the device table check, it is confirmed whether an entry having the device certificate acquired from the device 2 exists in the device table. A corresponding entry normally exists in the device table after Step S5 in FIG. 8 is performed.

When the corresponding entry exists in the device table, the device ID is identified from the entry in the device table (Step S22). Verified ownership registration table check is performed by using the identified device ID (Step S23). In the verified ownership registration table check, it is confirmed whether the entry that has stored the identified device ID therein exists in the verified ownership registration table. A corresponding entry normally does not exist in the verified ownership registration table when the owner verification of the device 2 is performed for the first time.

When a corresponding entry does not exist in the verified ownership registration table, validity check of the owner verification token is performed (Step S24). When a condition that an entry that has stored the owner verification token acquired from the device 2 therein exists in the user table and the expiration date of the entry is not expired is satisfied, the owner verification token is valid. When the condition is not satisfied, the owner verification token is invalid.

When the owner verification token is valid, the user ID corresponding to the owner verification token is identified from the entry in the user table that has stored the owner verification token therein (Step S25). Next, ownership registration table check is performed (Step S26). In the ownership registration table check, it is confirmed whether an entry having the device ID identified in Step S22 and the user ID identified in Step S25 exists in the ownership registration table. A corresponding entry normally exists in the ownership registration table after Step S5 in FIG. 8 is performed.

When a corresponding entry exists in the ownership registration table, a registration ID is identified from the entry in the ownership registration table (Step S27). A new entry including the registration ID identified in Step S27 and the device ID identified in Step S22 is stored in the verified ownership registration table (Step S28). As a result, the user 5 corresponding to the owner verification token is determined as the owner of the device 2.

By the registration ID identified in Step S27, an entry having the registration ID is read from the ownership registration table (Step S29). As a result, the owner verification ends as a success.

When a corresponding entry exists in the verified ownership registration table in Step S23, the registration ID is identified from the verified ownership registration table (Step S30). An entry is read from the ownership registration table in Step S29 on the basis of the registration ID identified in Step S30. As a result, the owner verification ends as a success.

When a corresponding entry does not exist in the device table (Step S21), the owner verification token is invalid (Step S24), or a corresponding entry does not exist in the ownership registration table (Step S26), an error is notified to the device 2 (Step S31). As a result, the owner verification ends as a failure.

As above, in the owner verification, the proper owner of the device 2 is determined with use of the owner verification token stored in the device 2. The information relating to the device for which the owner has been determined as a result of the owner verification is stored in the verified ownership registration table.

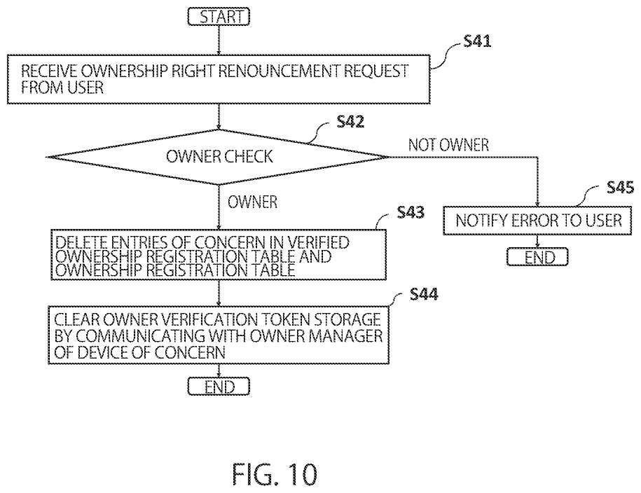

FIG. 10 is a flowchart diagram illustrating the operation of ownership right extinguishment processing. The ownership right extinguishment processing is performed by the ownership right extinguishment processor 16 in the registrar 1. An example in which the user 5 renounces the ownership right of the device 2 is described below.

First, an ownership right renouncement request is received from the user 5 (Step S41). The ownership right renouncement request includes the device ID of the device 2 to be renounced.

Next, owner check is performed (Step S42). In the owner check, it is confirmed that the user 5 is the owner of the device 2. When a condition that an entry having the device ID of the device 2 exists in the verified ownership registration table and the user ID of the user 5 is stored in an entry in the ownership registration table linked to the registration ID of the entry is satisfied, the user 5 is the owner of the device 2. When the condition is not satisfied, the user 5 is not the owner of the device 2.

When the user 5 is the owner of the device 2, the entry in the verified ownership registration table having the device ID of the device 2 and the entry in the ownership registration table having the registration ID of the entry in the verified ownership registration table are deleted (Step S43).

The owner verification token stored in the owner verification token storage 22 is caused to be deleted by communicating with the owner manager 21 of the device 2 (Step S44). As a result, the ownership right extinguishment processing is ended.

A new user can newly store an owner verification token in the device 2 as a result of the owner verification token being deleted in Step S44. As a result, the new user can be treated as the owner of the device 2 immediately after the ownership right extinguishment processing, by the owner verification. Even when the device 2 does not delete the owner verification token, an owner verification token can be newly stored (overwritten) when the expiration date of the owner verification token expires.

When the user 5 is not the owner of the device 2 (Step S42), an error is notified to the user 5 (Step S45). As a result, the ownership right extinguishment processing is ended.

As above, in the ownership right extinguishment processing, the registrar 1 extinguishes the ownership right regarding the device 2 (in other words, extinguishes information on the owner regarding the device 2) in accordance with an instruction from the proper owner of the device 2. The registrar 1 communicates with the device 2 and clears the content of the owner verification token storage 22 of the device 2. As a result, the owner verification in FIG. 9 can be immediately executed for the new owner of the device 2. For example, when the user 5 that has extinguished the ownership right hands over the device 2 to another user, the other user can efficiently register themselves as the new owner.

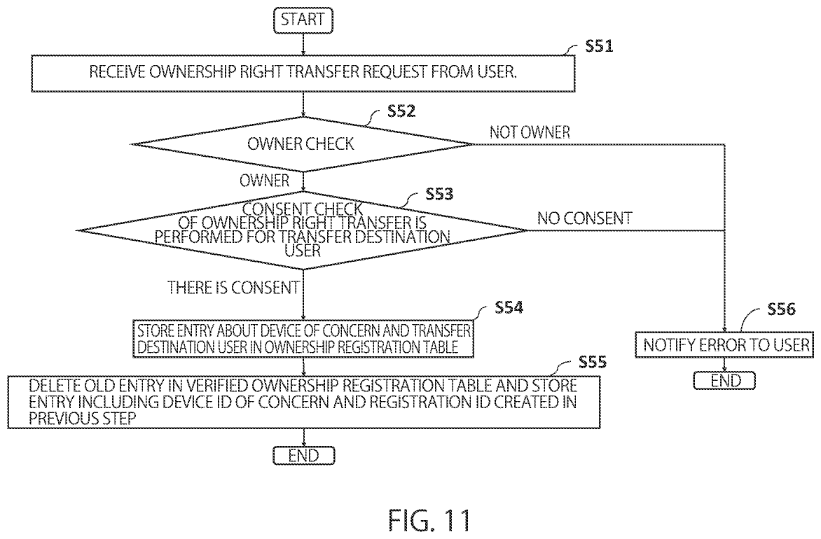

FIG. 11 is a flowchart diagram illustrating the operation of the ownership right transfer processing. The ownership right transfer processing is performed by the ownership right transfer processor 17 in the registrar 1. An example in which the user 5 transfers the ownership right of the device 2 to another user is described below.

First, an ownership right transfer request is received from the user 5 (Step S51). The ownership right transfer request includes the device ID of the device 2 that is a transfer target and the user ID of the user that is a transfer destination.

Next, the owner check is performed (Step S52). In the owner check, it is confirmed that the user 5 is the owner of the device 2. The specific processing content is similar to that of the owner check (Step S42 in FIG. 10) in the ownership right extinguishment processing.

When the user 5 is the owner of the device 2, consent check of the ownership right transfer is performed for the user that is the transfer destination (Step S53). When a consensus is gained from the user that is the transfer destination, a new entry including the device ID of the device 2 and the user ID of the user that is the transfer destination is stored in the ownership registration table (Step S54). In Step S53, the information on the connection destination CPS server may be demanded to be provided from the user that is the transfer destination. The information on the connection destination CPS server acquired from the user that is the transfer destination may be stored as well in Step S54.

Next, an old entry having the device ID of the device 2 is deleted from the verified ownership registration table. The new entry having the device ID of the device 2 and the registration ID of the entry in the ownership registration table stored in Step S54 is stored in the verified ownership registration table (Step S55).

When the user 5 is not the owner of the device 2 (Step S52) or consent from the user that is the transfer destination cannot be gained (Step S53), an error is notified to the user 5 (Step S56). As a result, the ownership right transfer processing is ended.

As above, in the ownership right transfer processing, the registrar 1 transfers the ownership right of the device 2 (in other words, changes the information on the owner of the device 2) by the instruction from the user 5 that is the transfer source of the device 2 and the consent by the user that is the transfer destination. The user ID is updated in the verified ownership registration table. Therefore, it is recognized that the user that is the transfer destination is the proper owner of the device 2 in the owner verification in FIG. 9 as well.

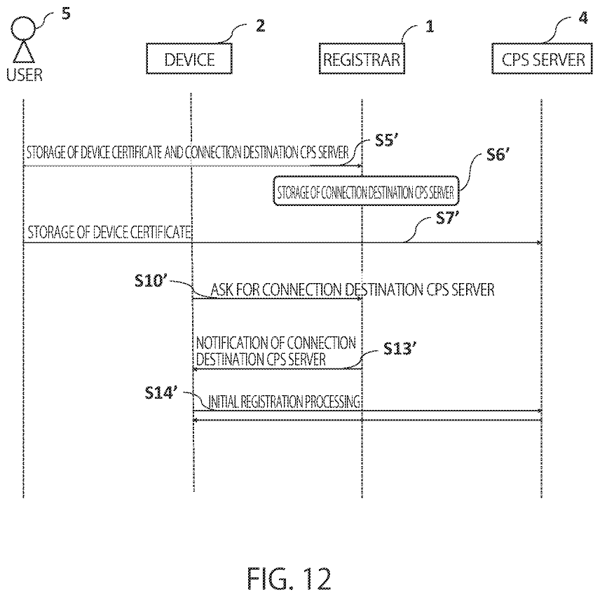

In order to show the effectiveness of the system according to this embodiment, a system that is the subject of the comparative example (a system of a comparative example) is described below with reference to FIG. 12 to FIG. 14. FIG. 12 is a sequence diagram illustrating the operation of the system of the comparative example. The operation illustrated in FIG. 12 is greatly different from the operation illustrated in FIG. 8 in that the owner verification (Step S12 in FIG. 8) does not exist. The processing from the demand of the owner verification token to the provision it (Steps S2 to S4), the processing of causing the device 2 to store therein the owner verification token (Steps S8 and S9), and the like do not exist as a result of not performing the owner verification.

In the operation in FIG. 12, the user 5 transmits a registration request including the device certificate and the URL of the CPS server 4 to the registrar 1 (Step S5′).

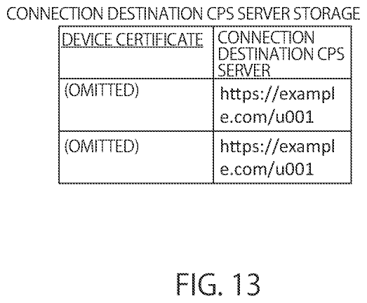

The registrar 1 stores therein the URL of the CPS server 4 by linking the URL of the CPS server 4 to the device certificate (Step S6′). FIG. 13 is a diagram showing one configuration example of information stored in the registrar 1.

Next, the user 5 registers a device certificate on the CPS server 4 (Step S7′). The device 2 asks the registrar 1 for the connection destination CPS server by presenting the device certificate (Step S10′). The registrar 1 acquires the URL of the CPS server 4 by reading an entry in which the device certificate is stored from the information shown in FIG. 13 and notifies the URL of the CPS server 4 to the device 2 (Step S13′). Then, the initial registration processing is performed as with Steps S14 to S15 in FIG. 8 (Step S14′).

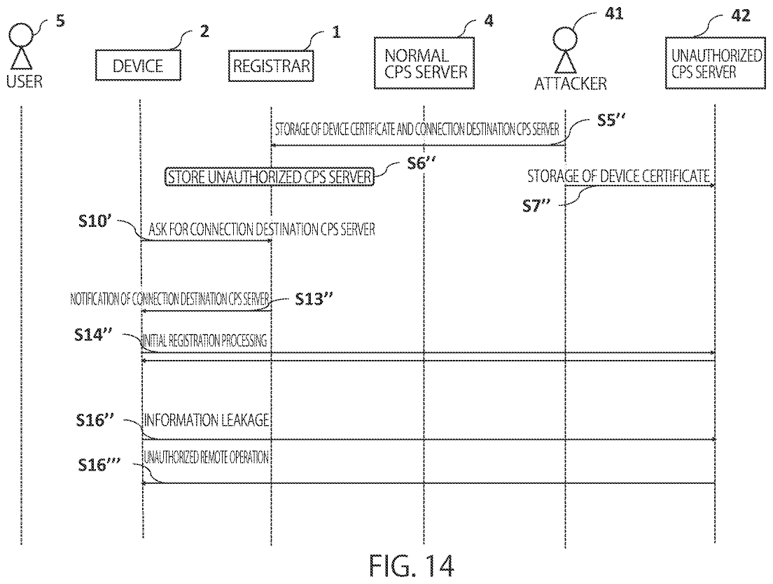

FIG. 14 is a sequence diagram illustrating a security risk in the system of the comparative example. As a premise, an attacker 41 has obtained the device certificate of the device 2. This situation easily occurs when the device certificate is widely published by a manufacturer of the device 2. Even if that is not the case, there is a high possibility that a seller that has sold the device 2 to the user 5 may be able to obtain the device certificate of the device 2.

The purpose of the attacker 41 is to guide the device 2 owned by the user 5 to an unauthorized CPS server 42 managed by the attacker 41 and steal information from the device 2 or perform unauthorized remote operation.

The attacker 41 transmits a registration request including the obtained device certificate of the device 2 and the URL of the CPS server 42 to the registrar 1 (Step S5″). The registrar 1 stores therein the URL of the CPS server 42 by linking the URL of the CPS server 4 to the device certificate of the device 2 (Step S6″). Next, the attacker 41 registers the device certificate on the CPS server 42 (Step S7″).

The device 2 asks the registrar 1 for the connection destination CPS server by presenting the device certificate (Step S10′). As with FIG. 12, the registrar 1 reads an entry in which the device certificate is stored, but the URL of the unauthorized CPS server 42 is stored in the entry. As a result, the registrar 1 notifies the URL of the unauthorized CPS server 42 to the device 2 as the connection destination CPS server (Step S13″).

The device 2 performs the initial registration processing with the unauthorized CPS server 42 (Step S14″). As a result, there is a fear that the device 2 may leak confidential information to the attacker 41 (Step S16″) or be subjected to unauthorized remote operation (Step S16′″) from the attacker 41, via the CPS server 42.

As above, in the system of the comparative example illustrated in FIG. 12, the attacker 41 can cause the registrar 1 to store therein an unauthorized connection destination server (CPS server 42) with use of the device certificate of the device 2. In this case, the registrar 1 guides the device 2 to the CPS server 42. As a result, there is a fear that the device 2 may leak information to the attacker 41 or be subjected to unauthorized control and the like from the attacker 41, via the CPS server 42.

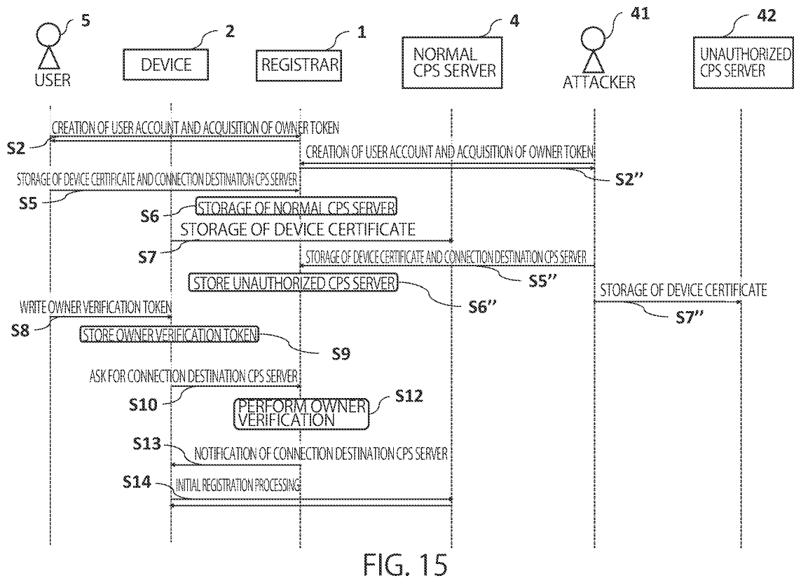

FIG. 15 is a sequence diagram illustrating the operation when an attack similar to that in FIG. 14 is encountered in the system of the first embodiment. As with the example illustrated in FIG. 8, the user 5 can store the normal CPS server 4 in the ownership registration table (Step S6) by performing the processing of generating a user account and acquiring an owner token (Step S2) and the processing of registering a device certificate and a connection destination CPS server (Step S5) with respect to the registrar 1. The user 5 causes the normal CPS server 4 to store therein the device certificate (Step S7).

Meanwhile, as with the user 5, the attacker 41 can register the unauthorized CPS server 42 on the ownership registration table by performing the processing in Step S2″ and Step S5″ (Step S6″). The attacker 41 causes the unauthorized CPS server 42 to store therein a device certificate (Step S7″).

At a time point after Step S6″ is performed, a total of two entries (one entry when there is a unique constraint on the device certificate), that is, the entry registered by the attacker and the normal entry registered by the user 5 are stored in the device table as entries having the device certificate of the device 2. A total of two entries, that is, the entry relating to the user 5 and the entry relating to the attacker 41 are stored in the user table. Different owner verification tokens are stored in the entry of the user 5 and the entry of the attacker 41.

A total of two entries, that is, an entry in which the connection destination CPS server (CPS server 4) for the device 2 specified by the user 5 is stored and an entry in which the connection destination CPS server (CPS server 42) for the device 2 specified by the attacker 41 is stored are stored in the ownership registration table.

The user 5 can write the owner verification token issued to the user 5 into the device 2 owned by the user 5 and cause the device 2 owned by the user 5 to store the owner verification token issued to the user 5 therein (Steps S8 and S9). Meanwhile, the attacker 41 does not own the device 2, and hence the owner verification token issued to the attacker 41 cannot be stored into the device 2.

The device 2 asks the registrar 1 for the connection destination CPS server with use of the owner verification token issued to the user 5 (Step S10). The registrar 1 performs owner verification (Step S12). The owner verification is performed as shown in FIG. 9. When the owner verification of the device 2 is performed for the first time, the entry about the user 5 is extracted from the ownership registration table based on the owner verification token issued to the user 5 in Steps S24 to S27 in FIG. 9. By Step S28 in FIG. 9, the user 5 corresponding to the owner verification token is determined as the owner of the device 2.

As a result of the owner verification in Step S12, the CPS server 4 specified by the user 5 is extracted as the connection destination CPS server. The registrar 1 notifies information including the URL of the CPS server 4 to the device 2 (Step S13). As a result, the device 2 can perform the initial registration processing (Step S14) with respect to the normal CPS server 4.

As illustrated in FIG. 15, the user 5 and the attacker 41 can cause the ownership registration table to store therein an entry that specifies the connection destination CPS server by presenting the device certificate of the device 2 to the registrar 1. However, it cannot be recognized that a being is the proper owner of the device 2 by only storing an entry in the ownership registration table. By performing the owner verification shown in FIG. 9, the proper owner of the device 2 is determined for the first time. The result of the determination is stored in the verified ownership registration table.

As above, in the first embodiment, the owner verification token is issued to the user 5 that owns the device 2, and the device 2 is caused to store therein the owner verification token of the user 5. The user 5 can be determined to be the proper owner of the device 2 by performing the owner verification on the basis of the owner verification token stored in the device 2. As a result, the registrar 1 can guide the device 2 to the proper connection destination CPS server specified by the user 5. A case where a being that is not the proper owner controls the device in an unauthorized controls or guides the device to the server of the being can be prevented.

### Second Embodiment

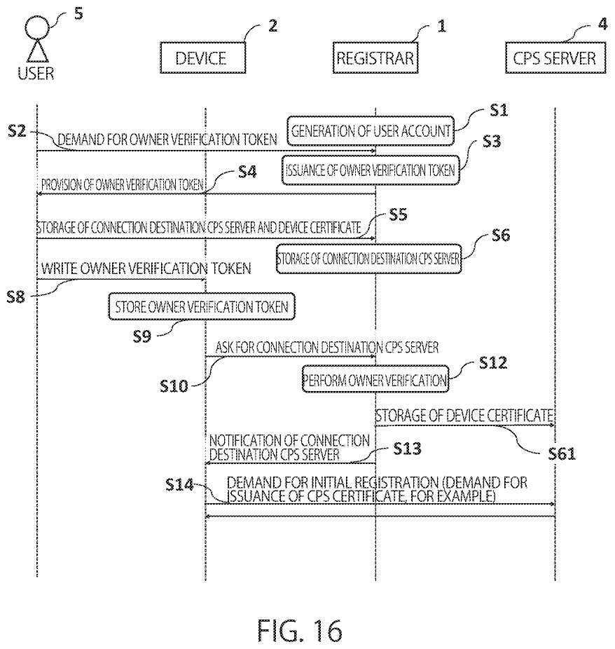

Processing of causing the CPS server 4 to store therein a device certificate may be incorporated in the processing of the registrar 1. FIG. 16 is a sequence diagram illustrating the operation of the system in the second embodiment. In the first embodiment, the user 5 causes the CPS server 4 to store therein a device certificate. The second embodiment is different in that the registrar 1 causes the CPS server 4 to store therein a device certificate.

In the operation illustrated in FIG. 16, processing in which the user 5 causes the CPS server 4 to store therein a device certificate does not exist. Processing of causing the CPS server 4 to store therein a device certificate (Step S61) is added immediately after the owner verification (Step S12). In Step S61, the connection destination CPS server notified in Step S13 is caused to store therein the device certificate acquired from the device table.

As above, in the second embodiment, the registrar 1 causes the CPS server 4 to store therein the device certificate. Burden on the user 5 can be reduced by incorporating the storage of the device certificate into the CPS server 4 into the processing of the registrar 1.

### Third Embodiment

In the first embodiment, the registrar 1 has two functions, that is, the function of the owner verification and the function of guiding the device to the connection destination CPS server. Out of the two functions, the function of guiding the device to the connection destination CPS server may be separated from the registrar 1.

In the third embodiment, a rendezvous server has the function of guiding the device to the connection destination CPS server. As with the example illustrated in FIG. 14, a case where an attacker causes the rendezvous server to store therein the unauthorized CPS server can be conceived. In this case, how to verify whether the CPS server notified by the rendezvous server is the CPS server of the proper owner on the device side becomes a problem.

In the third embodiment, the registrar 1 issues an ownership voucher (first ownership voucher) based on the result of the owner verification and provides the ownership voucher to the CPS server specified by the proper owner. The CPS server presents the provided ownership voucher to the device. As a result, the device side can confirm that the connection destination CPS server is the CPS server specified by the proper owner.

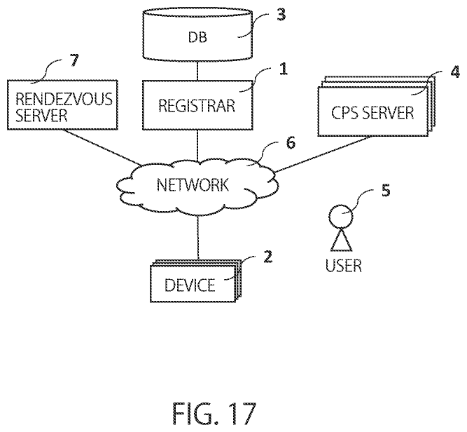

FIG. 17 is a system configuration diagram of one example of a CPS according to the third embodiment. The system illustrated in FIG. 17 is different from the system illustrated in FIG. 1 in that the system illustrated in FIG. 17 includes a rendezvous server 7. The rendezvous server 7 does not necessarily need to be physically separated from the registrar 1 and may be provided in the registrar 1.

The rendezvous server 7 responds to the query from the device 2 and guides the device 2 to the CPS server 4.

The registrar 1 verifies that the user 5 is the proper owner of the device 2 by the owner verification. The registrar 1 issues an ownership voucher of the device 2 in response to a demand from the CPS server specified by the user 5.

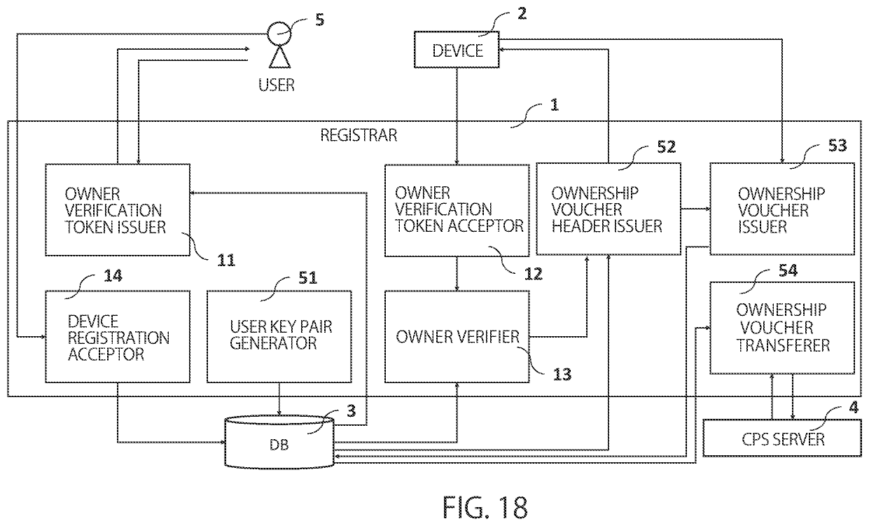

FIG. 18 is a block diagram illustrating one configuration example of the registrar 1 according to the third embodiment. The registrar 1 illustrated in FIG. 18 further includes a user key pair generator 51, an ownership voucher header issuer 52, an ownership voucher issuer 53, and an ownership voucher transferer 54 in addition to the components illustrated in FIG. 2. The illustration of the ownership right extinguishment processor 16 and the ownership right transfer processor 17 is omitted in FIG. 18.

The user key pair generator 51 generates a user public key (second decryption key) and a user private key (second encryption key) that form a pair for each user and stores the pair of the user public key and the user private key into the database 3.

The owner verifier 13 in the third embodiment performs the owner verification shown in FIG. 9 based on the owner verification token. The owner of the device 2 (the user 5 in the example in FIG. 18) is determined by the owner verification, and information on the owner is notified to the ownership voucher header issuer 52 as a result of the owner verification.

The ownership voucher header issuer 52 issues an ownership voucher header and transmits the ownership voucher header to the device 2. The ownership voucher header has a data structure defined by the FIDO Device Onboard standard, for example. The ownership voucher header includes the user public key of the owner of the device 2.

The ownership voucher issuer 53 accepts an HMAC (hash-based message authentication code or device authentication code) value described below from the device 2, issues an ownership voucher from the HMAC value and the ownership voucher header, and stores the ownership voucher in the database 3.

The ownership voucher transferer 54 accepts an transfer request (a request for transfer of the ownership voucher) from the CPS server 4. The ownership voucher transferer 54 issues a second ownership voucher including the ownership voucher stored in the database 3 and a digital signature applied with the user private key.

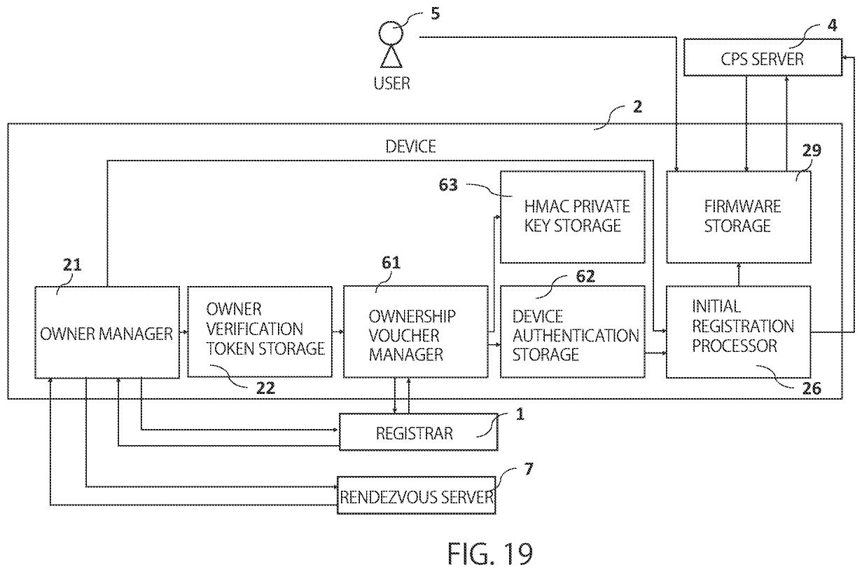

FIG. 19 is a block diagram illustrating one configuration example of the device 2 according to the third embodiment. The device 2 illustrated in FIG. 19 includes an ownership voucher manager 61, a device authentication storage 62, and an HMAC private key storage 63 in addition to the components illustrated in FIG. 3. The illustration of the owner verification token temporary storage 23, the CPS private key storage 27, the CPS certificate storage 28, the device private key storage 25, and the device certificate storage 24 is omitted in FIG. 19.

The owner manager 21 in the third embodiment accepts and stores therein an owner verification token from the user 5 and demands the issuance of an ownership voucher header by transmitting the owner verification token to the registrar 1. The owner manager 21 asks the rendezvous server 7 for information (a URL and the like) on the connection destination CPS server. The URL and the like of the rendezvous server 7 to be connected are stored in the owner manager 21 in advance.

The ownership voucher manager 61 communicates with the registrar 1 and performs processing necessary for the ownership voucher issuance. Specifically, the HMAC private key is generated and is stored in the HMAC private key storage 63. The ownership voucher manager 61 calculates a hash value (HMAC value) by the ownership voucher header and the HMAC private key. The ownership voucher manager 61 demands that the registrar 1 issue an ownership voucher by transmitting the HMAC value to the registrar 1. The URL and the like of the registrar 1 to be connected are stored in the ownership voucher manager 61 in advance.

The device authentication storage 62 stores therein device authentication information (described below) necessary for the ownership voucher issuance. The ownership voucher manager 61 can perform reading and writing with respect to the device authentication storage 62.

The HMAC private key storage 63 stores therein an HMAC private key for generating a message authentication code HMAC applied to the ownership voucher. The ownership voucher manager 61 can perform reading and writing with respect to the HMAC private key storage 63.

The initial registration processor 26 in the third embodiment performs initial registration processing, demands that the CPS server 4 present the second ownership voucher, and verifies the second ownership voucher based on the information stored in the device authentication storage 62.

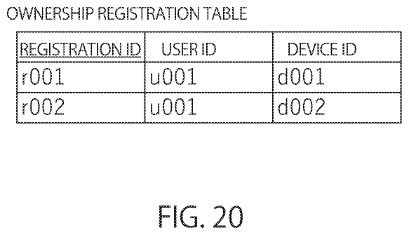

FIG. 20 is one configuration example of an ownership registration table in the third embodiment. The ownership registration table in the third embodiment is different from the first embodiment in that the ownership registration table in the third embodiment does not have the URL of the connection destination CPS server.

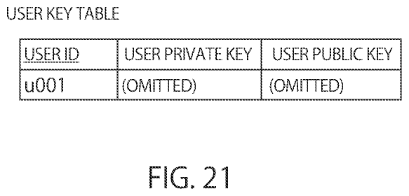

FIG. 21 is one configuration example of a user key table stored in the database 3 of the third embodiment. The user key table is a table that stores therein a pair of a user private key and a user public key for each user and has the user ID as the primary key.

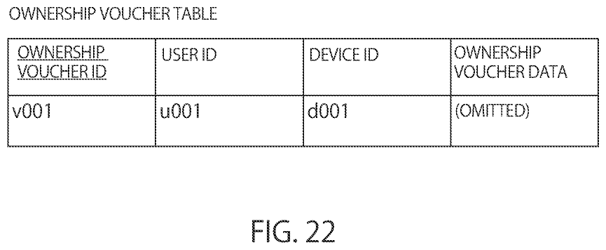

FIG. 22 is one configuration example of an ownership voucher table stored in the database 3 in the third embodiment. The ownership voucher table is a table that stores therein the ownership voucher for each set of a user and a device and has the ownership voucher ID as the primary key. The ownership voucher table has the user ID, the device ID, and the ownership voucher data as other items.

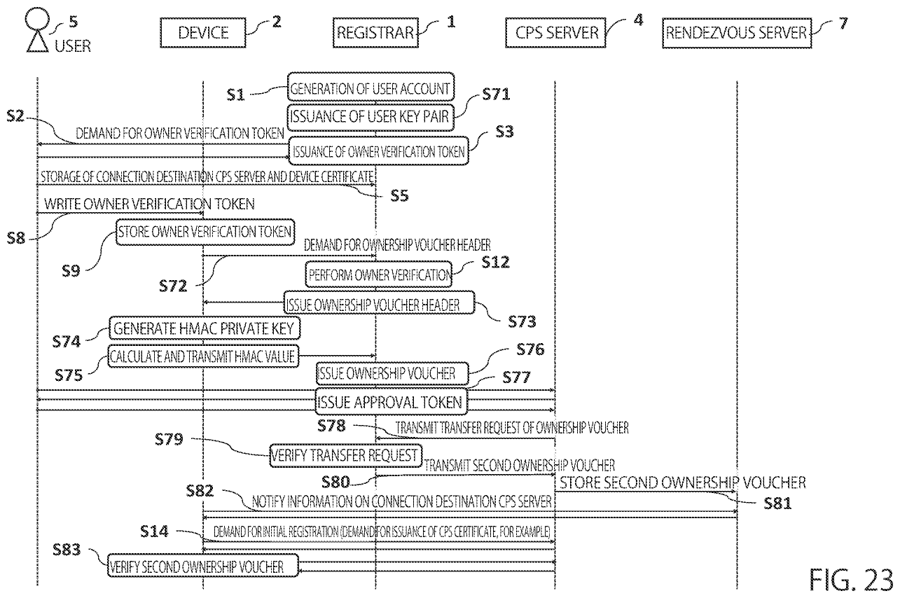

FIG. 23 is a sequence diagram illustrating the operation of the system in the third embodiment. In the operation in FIG. 23, a user account of the user 5 is created (Step S1) first as with the example in FIG. 8. Next, a user key pair is issued by the user key pair generator 51 in the registrar 1 (Step S71). A new entry including the user public key and the user private key of the user 5 is stored in the user key table.

Next, as with the example in FIG. 8, the user 5 demands that the registrar 1 issue an owner verification token (Step S2). The registrar 1 issues an owner verification token (Step S3) and transmits the owner verification token to the user 5. The user 5 causes the registrar 1 to store therein a device certificate (Step S5) and causes the device 2 to store therein the owner verification token (Step S9).

As with the Step S10 in FIG. 8, the owner manager 21 of the device 2 transmits the owner verification token and the like to the registrar 1. But t in the example in FIG. 23, the device 2 demands the issuance of an ownership voucher header (Step S72) instead of the provision of the information on the connection destination CPS server.

As with the example in FIG. 8, the owner verifier 13 of the registrar 1 performs owner verification (Step S12). When the owner verification succeeds, the owner verifier 13 reads an entry of the verified user from the ownership registration table. An entry having the user ID of the verified user is read from the user key table. The user public key can be acquired from the entry of the user key table.

The ownership voucher header issuer 52 generates an ownership voucher header including the user public key acquired by the owner verifier 13. The ownership voucher header issuer 52 issues the ownership voucher header to the device 2 and demands an HMAC value (Step S73).

The ownership voucher manager 61 of the device 2 receives the ownership voucher header from the registrar 1 and stores the ownership voucher header in the device authentication storage 62. The ownership voucher manager 61 newly generates an HMAC private key and stores the HMAC private key in the HMAC private key storage (Step S74). The ownership voucher manager 61 calculates an HMAC value for the ownership voucher header with use of the HMAC private key.

The ownership voucher manager 61 calculates the HMAC value by the ownership voucher header and the HMAC private key. The ownership voucher manager 61 transmits the HMAC value to the registrar 1 and demands the issuance of the ownership voucher (Step S75).

The ownership voucher issuer 53 of the registrar 1 accepts the HMAC value from the device 2 and issues an ownership voucher by the HMAC value and the ownership voucher header (Step S76). The ownership voucher issuer 53 stores a new entry in the ownership voucher table. The new entry includes the user ID and the device ID that the entry in the ownership registration table read in Step S12 has, and the ownership voucher.

The user 5 performs processing of issuing a token (hereinafter referred to as an approval token) with respect to the CPS server 4 (Step S77). The token indicates that approval of the user 5 is given regarding the transfer of the ownership voucher. The approval token is issued in accordance with the OAuth2 standard, for example. The user 5 notifies the start of approval processing regarding the transfer of the ownership voucher to the CPS server 4. The CPS server 4 redirects the user 5 to the registrar 1 and asks for approval with respect to the registrar 1. When the user 5 performs approval with respect to the registrar 1, an approval token is issued from the registrar 1 to the CPS server 4.

The CPS server 4 transmits a transfer request of the ownership voucher to the registrar 1 (Step S78). The transfer request includes information that has an approval token, the device ID for the ownership voucher transfer target, and a server public key of the CPS server 4. The transfer request includes a digital signature applied to such information with use of a server private key.

The ownership voucher transferer 54 of the registrar 1 accepts the transfer request of the ownership voucher from the CPS server 4. The ownership voucher transferer 54 verifies the transfer request (Step S79). The verification of the transfer request includes verification of whether the approval token is proper, for example. The ownership voucher transferer 54 verifies the digital signature that the transfer request has using the server public key. The ownership voucher transferer 54 verifies whether an entry including the user ID of the user authenticated by the approval token and the device ID of the target that the transfer request has exists in the ownership voucher table. When the entry exists in the ownership voucher table, the ownership voucher transferer 54 reads the ownership voucher from the entry.

When the verification succeeds, the ownership voucher transferer 54 expands the read ownership voucher by adding the server public key included in the transfer request to the ownership voucher. The ownership voucher transferer 54 creates a second ownership voucher by applying a digital signature to the expanded ownership voucher with the user private key. The ownership voucher transferer 54 transmits the created second ownership voucher to the CPS server 4 (Step S80).

The CPS server 4 causes the rendezvous server 7 to store therein the second ownership voucher acquired in Step S80 (Step S81). As a result, the rendezvous server 7 recognizes that the CPS server 4 is the proper connection destination CPS server of the device 2.

The device 2 asks the rendezvous server 7 for information on the connection destination CPS server. The rendezvous server 7 notifies connection information including the URL of the CPS server 4 to the device 2 (Step S82).

As with the example in FIG. 8, the initial registration processor 26 performs initial registration processing with the CPS server 4 on the basis of the connection information of the CPS server 4 (Step S14). The initial registration processor 26 receives the second ownership voucher from the CPS server 4 and verifies the second ownership voucher (Step S83).

In the verification of the second ownership voucher, verification of whether the hash value of the user public key stored in the device authentication storage 62 and the hash value of the user public key included in the second ownership voucher match with each other, for example, is performed. The HMAC value included in the second ownership voucher is verified using the HMAC private key stored in the HMAC private key storage 63. The digital signature included in the second ownership voucher is verified by the user public key. When the verification of the second ownership voucher succeeds, the device 2 confirms that the CPS server 4 is the proper connection destination.

As above, in the third embodiment, the registrar 1 determines the owner of the device 2 (the user 5 in the example in FIG. 23) by the owner verification and issues an ownership voucher. The ownership voucher can be transferred to the CPS server 4 that has received approval from the user 5. The CPS server 4 can be certified to be the CPS server of the user 5 by presenting the ownership voucher to the rendezvous server 7 and the device 2.

### Fourth Embodiment

In the third embodiment, the registrar 1 has two functions, that is, the function of the owner verification and the function of issuing an ownership voucher. In the fourth embodiment, the function of issuing an ownership voucher of these two functions of the registrar 1 is separated, and an ownership voucher issuance server having the function of issuing an ownership voucher is newly provided.

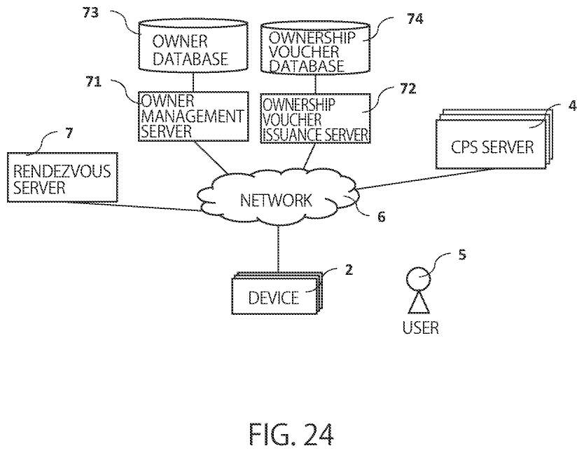

FIG. 24 is a system configuration diagram of one example of a CPS according to the fourth embodiment. The system illustrated in FIG. 24 is different from the system illustrated in FIG. 17 in that the system illustrated in FIG. 24 includes an owner management server 71, an ownership voucher issuance server (voucher issuance apparatus) 72, an owner database 73, and an ownership voucher database 74. The owner management server 71 and the owner database 73 correspond to the registrar 1 from which the function of issuing an ownership voucher has been removed and the database 3 used by the registrar 1, respectively.

The owner management server 71 and the ownership voucher issuance server 72 do not necessarily need to be physically separated from each other, and the ownership voucher issuance server 72 may be included in the owner management server 71. Either the owner management server 71 or the ownership voucher issuance server 72 may also serve as the rendezvous server 7.

The owner management server 71 has a function of performing owner verification and management, of the device. It is verified that the user 5 is the proper owner of the device 2 by the owner verification.

The ownership voucher issuance server 72 issues an ownership voucher of the device 2 in response to a demand from the CPS server specified by the user 5. At this time, the proper owner of the device 2 is confirmed by communicating with the owner management server 71.

The owner database 73 is a storage for storing therein and managing information relating to the owner by the owner management server 71.

The ownership voucher database 74 is a storage for storing therein and managing information relating to the ownership voucher by the ownership voucher issuance server 72.

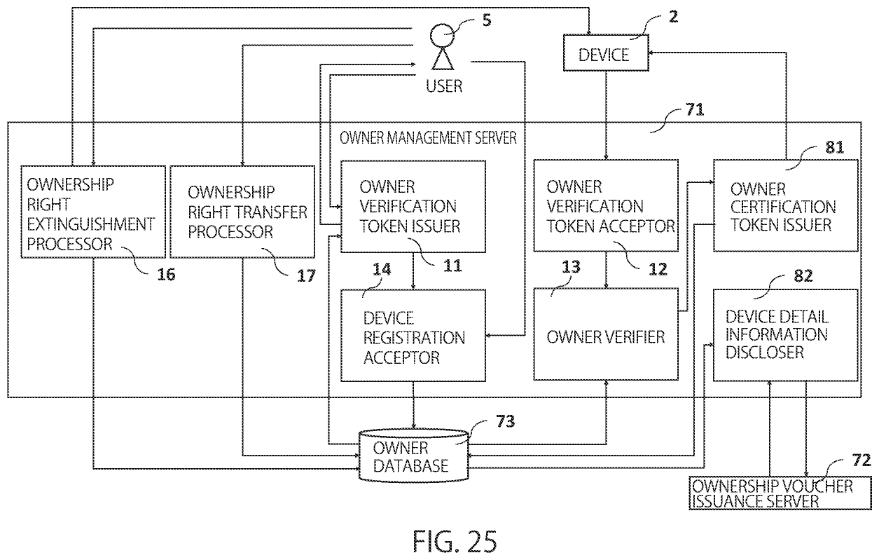

FIG. 25 is a block diagram illustrating one configuration example of the owner management server 71 according to the fourth embodiment. The configuration of the owner management server 71 illustrated in FIG. 25 basically conforms to the configuration of the registrar 1 illustrated in FIG. 2. When compared to the example in FIG. 2, the owner management server 71 illustrated in FIG. 25 does not include the connection destination CPS server notifier 15. There is also a difference in that an owner certification token issuer (second token issuer) 81 and a device detail information discloser (information discloser) 82 are included.

The owner verifier 13 performs the owner verification shown in FIG. 9 based on the owner verification token. The owner (the user 5 in the example in FIG. 25) of the device 2 is determined by the owner verification.

The owner certification token issuer 81 acquires the result of the owner verification by the owner verifier 13 and issues an owner certification token (second token) indicating the proper owner of the device 2 to the device 2.

The device detail information discloser 82 provides data necessary for the verification of the owner certification token to the ownership voucher issuance server 72. Specifically, the device detail information discloser 82 receives the owner certification token from the ownership voucher issuance server 72 and discloses the device certificate of the device 2 and the user ID of the owner of the device 2 linked to the owner certification token.

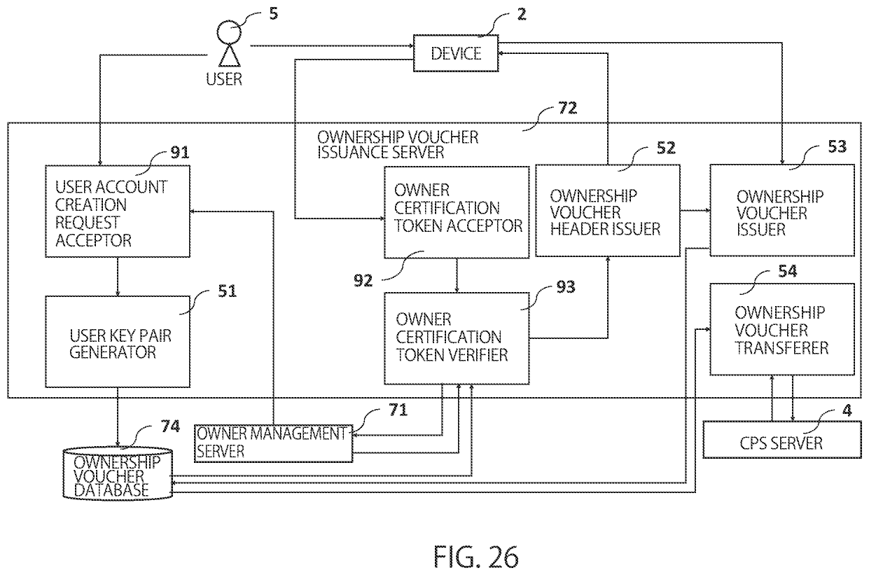

FIG. 26 is a block diagram illustrating one configuration example of the ownership voucher issuance server 72 according to the fourth embodiment. The ownership voucher issuance server 72 illustrated in FIG. 26 includes the user key pair generator 51, the ownership voucher header issuer 52, the ownership voucher issuer 53, and the ownership voucher transferer 54 that are the components of the registrar 1 illustrated in FIG. 18. A user account creation request acceptor 91, an owner certification token acceptor (second token acceptor) 92, and an owner certification token verifier 93 (second token verifier) are newly included.

In accordance with a demand from the user 5, the user account creation request acceptor 91 receives information on the user 5 from the owner management server 71 and instructs the user key pair generator 51 to generate a user key pair.

The owner certification token acceptor 92 accepts the owner certification token and the device certificate from the device 2 and accepts a demand for verifying the owner certification token from the device 2.

The owner certification token verifier 93 receives necessary data (for example, information on whether the owner certification token is valid, information on the device 2, and information on the owner of the device 2) from the owner management server 71, verifies the owner certification token, and notifies the information on the owner to the ownership voucher header issuer 52 as the result of the verification.

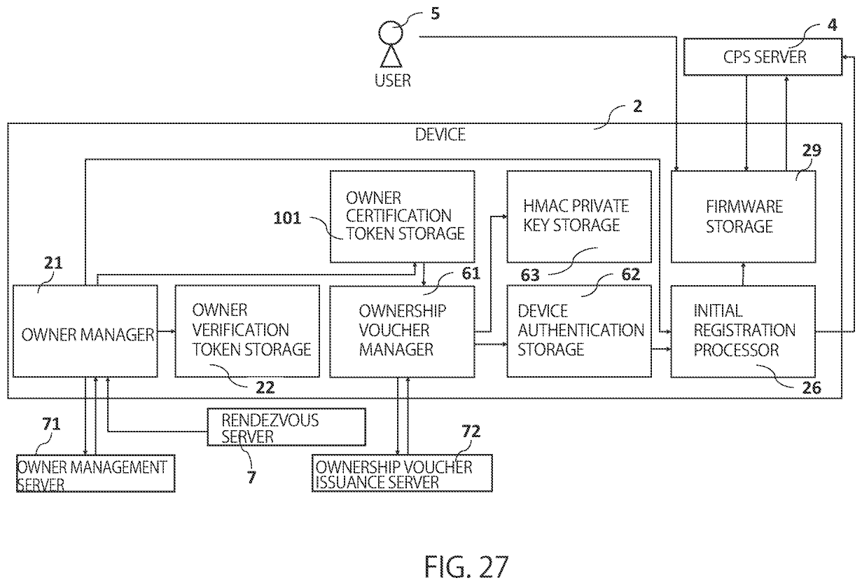

FIG. 27 is a block diagram illustrating one configuration example of the device 2 according to the fourth embodiment. The device 2 illustrated in FIG. 27 includes an owner certification token storage 101 in addition to the components illustrated in FIG. 19.

The owner manager 21 of the device 2 in the fourth embodiment demands the issuance of an owner certification token by accepting and storing therein an owner verification token from the user 5 and transmitting the owner verification token to the owner management server 71. In the owner manager 21, the URL and the like of the owner management server to which the owner manager 21 is to connect are stored in advance.

The ownership voucher manager 61 of the device 2 in the fourth embodiment performs processing necessary for the ownership voucher issuance by communicating with the ownership voucher issuance server 72. Specifically, the issuance of the ownership voucher is demanded by transmitting an HMAC value to the ownership voucher issuance server 72. The URL and the like of the ownership voucher issuance server 72 to be connected are stored in the ownership voucher manager 61 in advance.

The owner certification token storage 101 stores therein the owner certification token received from the owner management server 71. The owner manager 21 can write into the owner certification token storage 101, and the owner manager 21 and the ownership voucher manager 61 can read from the owner certification token storage 101.

The owner database 73 in the fourth embodiment has a device table, a user table, and a verified ownership registration table similar to those of the first embodiment and has an ownership registration table (see FIG. 20) similar to that of the third embodiment. The owner database 73 newly has an owner certification token table.

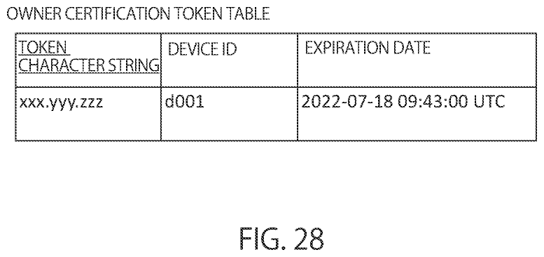

FIG. 28 is one configuration example of the owner certification token table. The owner certification token table is a table that stores therein the owner certification token for each device and has a token character string of the owner certification token as the primary key. The ownership voucher table has the expiration date of the owner certification token and the device ID as other items.

The ownership voucher database 74 in the fourth embodiment has a user key table (see FIG. 21) and an ownership voucher table (see FIG. 22) similar to those of the third embodiment.

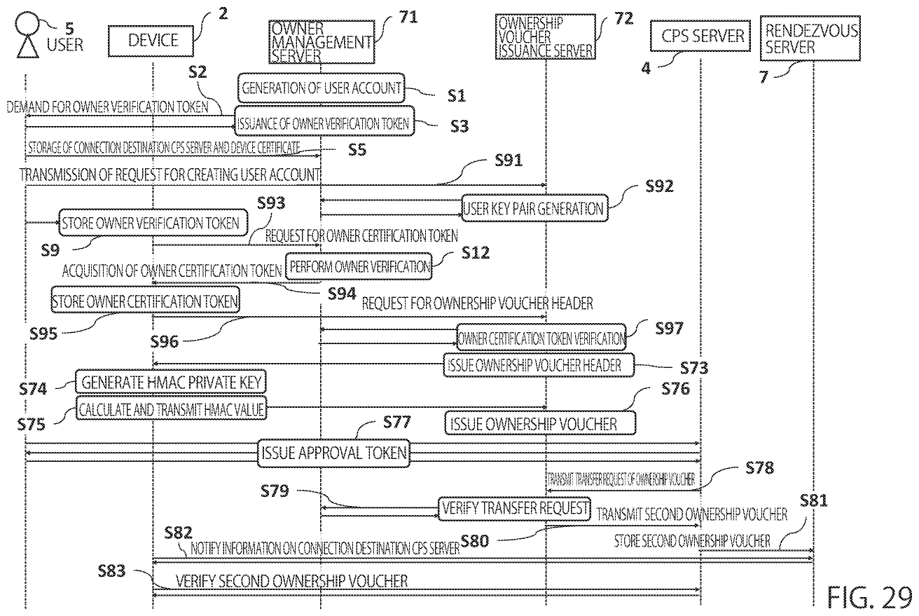

FIG. 29 is a sequence diagram illustrating the operation of the system in the fourth embodiment. In the operation of FIG. 29, a user account of the user 5 is created in the owner management server 71 (Step S1) first as with the example in FIG. 8. Next, the user 5 demands that the owner management server 71 issue an owner verification token (Step S2). The owner management server 71 issues an owner verification token (Step S3) and transmits the owner verification token to the user 5. The user 5 causes the owner management server 71 to store therein a device certificate (Step S5).

Next, the user 5 transmits a request for creating a user account to the ownership voucher issuance server 72 (Step S91).

The user account creation request acceptor 91 of the ownership voucher issuance server 72 communicates with the owner management server 71 and confirms the user ID of the user 5 that is a transmitter of the user account creation request. This is realized with use of the OpenID Connect standard, for example. Next, the user key pair generator 51 of the ownership voucher issuance server 72 stores a new entry including the user private key and the user public key of the user 5 in the user key table of the ownership voucher database 74 (Step S92).

As with the example in FIG. 8, the user 5 causes the device 2 to store therein the owner verification token (Step S9). The owner manager 21 in the device 2 transmits the owner verification token to the owner management server 71. Although the operation is similar to that of the example in FIG. 8, the device 2 demands the issuance of an owner certification token (Step S93) instead of the provision of the information on the connection destination CPS server in the example in FIG. 29.

As with the example in FIG. 8, the owner verifier 13 of the owner management server 71 performs owner verification (Step S12). When the verification succeeds, the owner verifier 13 reads an entry about the user (verified user) for which the verification has succeeded from the ownership registration table.

The owner management server 71 newly issues an owner certification token for the device 2 and saves the owner certification token in the owner certification token table. The expiration date of the owner certification token is set to 24 hours from the time of issuance, for example. The owner management server 71 replies to the device 2 with the issued owner certification token (Step S94).

The owner manager 21 of the device 2 receives the owner certification token and saves the owner certification token in the owner certification token storage 101 (Step S95). The ownership voucher manager 61 presents the owner certification token and the device certificate to the ownership voucher issuance server 72 and demands the issuance of an ownership voucher header (Step S96).

The owner certification token acceptor 92 of the ownership voucher issuance server 72 receives the owner certification token and the device certificate from the device 2. The owner certification token verifier 93 performs owner certification token verification described below in cooperation with the owner management server 71 (Step S97). The device certificate received by the owner certification token acceptor 92 is referred to as a first device certificate in this embodiment.

When the owner certification token verification of the owner certification token verifier 93 succeeds, the ownership voucher header issuer 52 issues an ownership voucher header on the basis of the demand from the device 2 (Step S73).

As with the example in FIG. 23, the device 2 newly generates an HMAC private key (Step S74). The device 2 transmits an HMAC value to the ownership voucher issuance server 72 (Step S75). The ownership voucher issuance server 72 issues an ownership voucher (Step S76).

As with the example in FIG. 23, the user 5 performs processing of issuing an approval token with respect to the CPS server 4 (Step S77). The approval token may be issued by the owner management server 71 that has received approval from the user 5 in accordance with the OAuth2 standard. The CPS server 4 transmits a transfer request of the ownership voucher to the ownership voucher issuance server 72 (Step S78).

The ownership voucher issuance server 72 verifies the transfer request (Step S79). As described above, when the owner management server 71 issues an approval token, the approval token may be transmitted to the owner management server 71 in the verification in Step S79 and it may be confirmed whether the approval token indicates that the approval is performed by the user 5.

Next, the ownership voucher issuance server 72 transmits the created second ownership voucher to the CPS server 4 (Step S80). The CPS server 4 causes the rendezvous server 7 to store therein the second ownership voucher (Step S81). The device 2 acquires connection information of the CPS server 4 from the rendezvous server 7 (Step S82). The device 2 performs initial registration processing with the CPS server 4 and the verification of the second ownership voucher (Step S83).

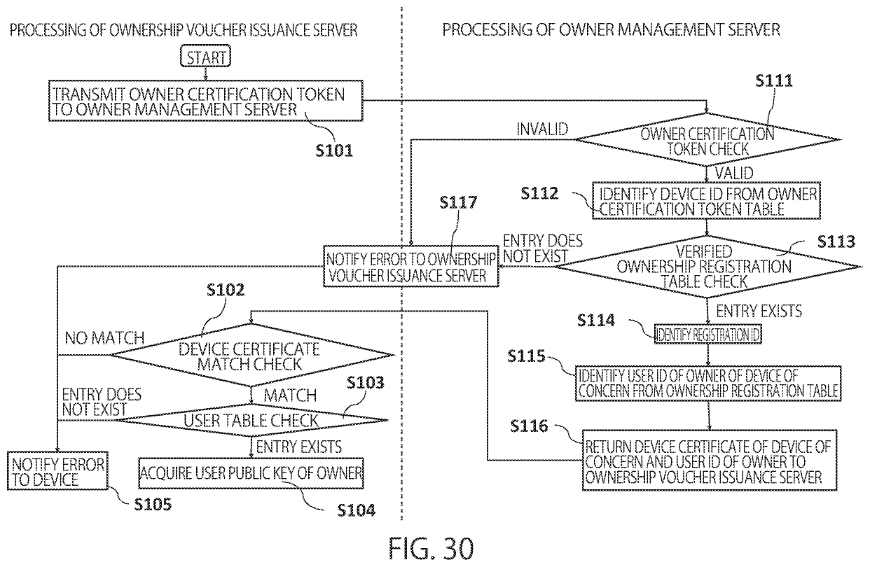

FIG. 30 is a flowchart diagram illustrating the operation of the owner certification token verification. The owner certification token verification is performed by the ownership voucher issuance server 72 and the owner management server 71 in cooperation with each other. First, the owner certification token verifier 93 of the ownership voucher issuance server 72 transmits the owner certification token acquired from the device 2 to the owner management server 71 (Step S101).

The processing from Steps S111 to S117 is performed by the device detail information discloser 82 of the owner management server 71. First, the owner certification token received from the ownership voucher issuance server 72 is checked (Step S111). In the check of the owner certification token, it is verified whether a condition that an entry in the owner certification token table having the owner certification token exists and the expiration date of the entry is on or after the current date and time is satisfied. When the condition is satisfied, the owner certification token is valid. When the condition is not satisfied, the owner certification token is invalid.

When the owner certification token is valid, the device ID is identified from the entry in the owner certification table (Step S112). Next, the verified ownership registration table check is performed (Step S113). In this check, it is confirmed whether an entry in the verified ownership registration table having the device ID identified in Step S112 exists. The entry normally exists after the owner verification for the device 2 is performed.

When a corresponding entry exists in the verified ownership registration table, the registration ID is identified from the entry (Step S114).

Next, the user ID of the owner (user 5) of the device 2 can be identified from the entry in the ownership registration table having the identified registration ID (Step S115).

Next, the device certificate is acquired from the entry in the device table having the identified device ID. The device certificate and the user ID identified in Step S115 are transmitted to the ownership voucher issuance server 72 (Step S116).

When the owner certification token is invalid (Step S111) or when a corresponding entry does not exist in the verified ownership registration table (Step S113), an error is notified to the ownership voucher issuance server 72 (Step S117).

The processing in Steps S102 to S105 is performed by the owner certification token verifier 93 of the ownership voucher issuance server 72. When the device certificate and the user ID are received from the owner management server 71, device certificate match check is performed (Step S102). In the device certificate match check, it is confirmed whether the device certificate received from the owner management server 71 and the first device certificate received from the device 2 match with each other.

When the device certificate match with each other, user check is performed (Step S103). In the user check, it is confirmed whether an entry in the user key table having the user ID received from the owner management server 71 exists. The entry normally exists when a request for creating a user account is transmitted to the ownership voucher issuance server 72 from the user 5.

When a corresponding entry exists in the user key table, the user public key is acquired from the entry (Step S104). The owner certification token verification ends as a success.

When an error is notified from the owner management server 71 (Step S117), the device certificates do not match with each other (Step S102), or a corresponding entry does not exist in the user key table (Step S103), an error is notified to the device 2 (Step S105). The owner certification token verification ends as a failure.

As above, in the fourth embodiment, the ownership voucher issuance server 72 that issues an ownership voucher can cooperate with the owner management server 71 that performs the owner verification with use of the owner certification token. As a result, the ownership voucher issuance server 72 can issue an ownership voucher to the proper owner (the user 5 in FIG. 29) of the device 2.

It is also possible to combine another initial registration approach with the fourth embodiment. For example, a server that issues a CPS certificate to the device 2 may be launched, and the server may accept an owner certification token issued by the owner management server 71. According to this configuration, the user 5 that is the proper owner of the device 2 is allowed to be able to issue a CPS certificate for the device 2.

While certain embodiment have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### Clauses

Clause 1. An information processing apparatus, comprising:
a first token issuer configured to issue a first token in response to a token issuance demand from a user;
a first storage configured to store information on the user and the first token;
a second storage configured to store ownership registration information of a device owned by the user;
a first token acceptor configured to accept the first token provided from the device;
an owner verifier configured to perform owner verification including verifying whether information on the device providing the first token is stored in the second storage and whether the first token accepted by the first token acceptor matches with the first token in the first storage, and determine the user corresponding to the first token for which the owner verification succeeds to be an owner of the device; and
a third storage configured to store verified data including information on the device for which the owner is determined.
   Clause 2. The information processing apparatus according to clause 1, wherein:
the first token has an expiration date; and
the owner verification includes verification based on the expiration date of the first token.
   Clause 3. The information processing apparatus according to clause 1 or 2, further comprising:
a device registration acceptor configured to accept a device certificate including a first decryption key of the device from the user; and
a fourth storage configured to store data including the device certificate accepted by the device registration acceptor, wherein the first token acceptor accepts the first token provided by the device on a basis of verification of whether the device has a first encryption key corresponding to the first decryption key included in the device certificate stored in the fourth storage.
   Clause 4. The information processing apparatus according to any one of clauses 1 to 3, further comprising a connection destination notifier configured to notify information on a connection destination server to the device, wherein the second storage stores the information on the connection destination server in association with the information on the device for which the owner is determined.
   Clause 5. The information processing apparatus according to any one of clauses 1 to 4, further comprising an extinguishment processor configured to delete information relating to the verified data in the third storage by a demand from the user for which owner verification has succeeded.
   Clause 6. The information processing apparatus according to any one of clauses 1 to 5, further comprising an authority transfer processor configured to update the verified data in the third storage to information relating to a new user by performing processing of changing the owner of the device to the new user on a basis of a demand from the user for which owner verification has succeeded and a demand from the new user.
   Clause 7. The information processing apparatus according to any one of clauses 1 to 6, further comprising:
a user key pair generator configured to generate a second decryption key and a second encryption key that form a pair for each user;
an ownership voucher header issuer configured to issue an ownership voucher header including the second decryption key to the device;
an ownership voucher issuer configured to accept a device authentication code from the device and issue a first ownership voucher on a basis of the ownership voucher header and the device authentication code; and
an ownership voucher transferer configured to issue an second ownership voucher including the first ownership voucher and data encrypted by the second encryption key to a server that is a connection destination of the device for which the owner is determined.
   Clause 8. The information processing apparatus according to any one of clauses 1 to 7, further comprising a second token issuer configured to issue a second token indicating the user that is an owner of the device by receiving a demand from the device.
   Clause 9. The information processing apparatus according to clause 8, further comprising:
a user account creation request acceptor configured to create a user account including information on the user in accordance with a demand from the user;
a device registration acceptor configured to accept a device certificate including a first decryption key of the device from the user;
a second token acceptor configured to accept a demand for verifying the second token and to accept a first device certificate held by the device from the device;
an information discloser configured to disclose information including the user relating to the second token and to disclose the device certificate; and
a second token verifier configured to verify the second token on a basis of the information including the user and the device certificate disclosed by the information discloser, the first device certificate, and information on the user of the user account.
   Clause 10. An information processing system, comprising:
the information processing apparatus according to clause 2; and
the device, wherein the device includes:
   a fifth storage configured to store data including the first token; and
   an owner manager configured to transmit the first token to the information processing apparatus.
      Clause 11. The information processing system according to clause 10, wherein the owner manager causes the fifth storage to store data including the first token only when the expiration date of the first token stored in the fifth storage is expired or when the first token is not stored in the fifth storage.
      Clause 12. The information processing system according to clause 10 or 11, wherein: the device includes an initial registration processor configured to perform initial registration processing on a server that is a connection destination; and
the information processing apparatus notifies information on the server that is the connection destination to the device.
   Clause 13. The information processing system according to clause 12, wherein the initial registration processing includes processing of demanding that the server that is the connection destination issue a certificate for server created by an encryption key that the server has.
   Clause 14. The information processing system according to any one of clauses 10 to 13, comprising a voucher issuance apparatus including:
a user key pair generator configured to generate a second decryption key and a second encryption key that form a pair for each user;
an ownership voucher header issuer configured to issue an ownership voucher header including the second decryption key to the device;
an ownership voucher issuer configured to accept a device authentication code from the device and issue a first ownership voucher on a basis of the ownership voucher header and the device authentication code; and
an ownership voucher transferer configured to issue a second ownership voucher including the first ownership voucher and data encrypted by the second encryption key to a server that is a connection destination of the device for which the owner is determined.
   Clause 15. The information processing system according to clause 14, wherein:
the information processing apparatus includes:
   a second token issuer configured to issue a second token indicating the user that is an owner of the device by receiving a demand from the device;
   a device registration acceptor configured to accept a device certificate including a first decryption key of the device from the user; and
   an information discloser configured to disclose information including the user relating to the second token and to disclose the device certificate; and
the voucher issuance apparatus includes:
   a user account creation request acceptor configured to create a user account including information on the user in accordance with a demand from the user;
   a second token acceptor configured to accept a demand for verifying the second token and to accept a first device certificate held by the device from the device; and
   a second token verifier configured to verify the second token on a basis of the information including the user and the device certificate disclosed by the information discloser, the first device certificate, and information on the user of the user account.
      Clause 16. A non-transitory computer readable medium having a computer program stored therein which when executed by a computer, causes the computer to perform processes, comprising:
issuing a first token in response to a token issuance demand from a user;
storing information on the user and the first token in a first storage;
storing ownership registration information of a device owned by the user in a second storage;
accepting the first token provided from the device;
performing owner verification including verifying whether information on the device providing the first token is stored in the second storage and whether the first token accepted by the first token acceptor matches with the first token in the first storage, and determining the user corresponding to the first token for which the owner verification succeeds to be an owner of the device; and
storing verified data including information on the device for which the owner is determined, in a third storage.

1. An information processing apparatus, comprising:
a first token issuer configured to issue a first token in response to a token issuance demand from a user;
a first storage configured to store information on the user and the first token;
a second storage configured to store ownership registration information of a device owned by the user;
a first token acceptor configured to accept the first token provided from the device;
an owner verifier configured to perform owner verification including verifying whether information on the device providing the first token is stored in the second storage and whether the first token accepted by the first token acceptor matches with the first token in the first storage, and determine the user corresponding to the first token for which the owner verification succeeds to be an owner of the device; and
a third storage configured to store verified data including information on the device for which the owner is determined.

2. The information processing apparatus according to claim 1, wherein:
the first token has an expiration date; and
the owner verification includes verification based on the expiration date of the first token.

3. The information processing apparatus according to claim 1, further comprising:
a device registration acceptor configured to accept a device certificate including a first decryption key of the device from the user; and
a fourth storage configured to store data including the device certificate accepted by the device registration acceptor, wherein the first token acceptor accepts the first token provided by the device on a basis of verification of whether the device has a first encryption key corresponding to the first decryption key included in the device certificate stored in the fourth storage.

4. The information processing apparatus according to claim 1, further comprising a connection destination notifier configured to notify information on a connection destination server to the device, wherein the second storage stores the information on the connection destination server in association with the information on the device for which the owner is determined.

5. The information processing apparatus according to claim 1, further comprising an extinguishment processor configured to delete information relating to the verified data in the third storage by a demand from the user for which owner verification has succeeded.

6. The information processing apparatus according to claim 1, further comprising an authority transfer processor configured to update the verified data in the third storage to information relating to a new user by performing processing of changing the owner of the device to the new user on a basis of a demand from the user for which owner verification has succeeded and a demand from the new user.

7. The information processing apparatus according to claim 1, further comprising:
a user key pair generator configured to generate a second decryption key and a second encryption key that form a pair for each user;
an ownership voucher header issuer configured to issue an ownership voucher header including the second decryption key to the device;
an ownership voucher issuer configured to accept a device authentication code from the device and issue a first ownership voucher on a basis of the ownership voucher header and the device authentication code; and
an ownership voucher transferer configured to issue an second ownership voucher including the first ownership voucher and data encrypted by the second encryption key to a server that is a connection destination of the device for which the owner is determined.

8. The information processing apparatus according to claim 1, further comprising a second token issuer configured to issue a second token indicating the user that is an owner of the device by receiving a demand from the device.

9. The information processing apparatus according to claim 8, further comprising:
a user account creation request acceptor configured to create a user account including information on the user in accordance with a demand from the user;
a device registration acceptor configured to accept a device certificate including a first decryption key of the device from the user;
a second token acceptor configured to accept a demand for verifying the second token and to accept a first device certificate held by the device from the device;
an information discloser configured to disclose information including the user relating to the second token and to disclose the device certificate; and
a second token verifier configured to verify the second token on a basis of the information including the user and the device certificate disclosed by the information discloser, the first device certificate, and information on the user of the user account.

10. An information processing system, comprising:
the information processing apparatus according to claim 2; and
the device, wherein the device includes:
a fifth storage configured to store data including the first token; and
an owner manager configured to transmit the first token to the information processing apparatus.

11. The information processing system according to claim 10, wherein the owner manager causes the fifth storage to store data including the first token only when the expiration date of the first token stored in the fifth storage is expired or when the first token is not stored in the fifth storage.

12. The information processing system according to claim 10, wherein:
the device includes an initial registration processor configured to perform initial registration processing on a server that is a connection destination; and
the information processing apparatus notifies information on the server that is the connection destination to the device.

13. The information processing system according to claim 12, wherein the initial registration processing includes processing of demanding that the server that is the connection destination issue a certificate for server created by an encryption key that the server has.

14. The information processing system according to claim 10, comprising a voucher issuance apparatus including:
a user key pair generator configured to generate a second decryption key and a second encryption key that form a pair for each user;
an ownership voucher header issuer configured to issue an ownership voucher header including the second decryption key to the device;
an ownership voucher issuer configured to accept a device authentication code from the device and issue a first ownership voucher on a basis of the ownership voucher header and the device authentication code; and
an ownership voucher transferer configured to issue a second ownership voucher including the first ownership voucher and data encrypted by the second encryption key to a server that is a connection destination of the device for which the owner is determined.

15. The information processing system according to claim 14, wherein:
the information processing apparatus includes:
a second token issuer configured to issue a second token indicating the user that is an owner of the device by receiving a demand from the device;
a device registration acceptor configured to accept a device certificate including a first decryption key of the device from the user; and
an information discloser configured to disclose information including the user relating to the second token and to disclose the device certificate; and
the voucher issuance apparatus includes:
a user account creation request acceptor configured to create a user account including information on the user in accordance with a demand from the user;
a second token acceptor configured to accept a demand for verifying the second token and to accept a first device certificate held by the device from the device; and
a second token verifier configured to verify the second token on a basis of the information including the user and the device certificate disclosed by the information discloser, the first device certificate, and information on the user of the user account.

16. A non-transitory computer readable medium having a computer program stored therein which when executed by a computer, causes the computer to perform processes, comprising:
issuing a first token in response to a token issuance demand from a user;
storing information on the user and the first token in a first storage;
storing ownership registration information of a device owned by the user in a second storage;
accepting the first token provided from the device;
performing owner verification including verifying whether information on the device providing the first token is stored in the second storage and whether the first token accepted by the first token acceptor matches with the first token in the first storage, and determining the user corresponding to the first token for which the owner verification succeeds to be an owner of the device; and
storing verified data including information on the device for which the owner is determined, in a third storage.
